(19) United States
(12) Patent Application Publication
(10) Pub. No.: US 2014/0098202 A1
(43) Pub. Date: Apr. 10, 2014

(54) THREE-DIMENSIONAL VIEWING SYSTEM

(71) Applicant: Hoi Ming CHAN, Hong Kong (HK)

(72) Inventor: Hoi Ming CHAN, Hong Kong (HK)

(21) Appl. No.: 13/646,750

(22) Filed: Oct. 8, 2012

(51) Int. Cl. H04N 13/04

(52) U.S. Cl. 348/56; 348/51; 348/E13.075

(57) ABSTRACT

A three-dimensional viewing system includes a television having an electric circuit provided therein for the generation of alternating left-eye image and right-eye image on a screen, a micro controller unit provided inside the television and configured to extract a vertical synchronizing signal therefrom, a signal transmitting system for directly transmitting the vertical synchronizing signal to a pair of three-dimensional shutter glasses to be worn by the viewer in front of the television. The shutter glasses include left and right liquid crystal shutter lenses adapted to receive the vertical synchronizing signal and produce alternating transparency and opacity of the left and right shutter lenses. A switch unit connected to the left and right shutter lenses for independently switching the transparency and opacity thereof so that left eye of the viewer sees the left-eye image and right eye of the viewer sees the right-eye image to perceive a three-dimensional image.

### FIELD OF THE TECHNOLOGY

The present application relates to a three-dimensional viewing system.

### BACKGROUND

It is believed that three-dimensional images would be a trend of the television and entertainment business. Nowadays, there are various three-dimensional viewing means, such as red and blue filter glasses, polarized glasses, autostereoscopic, and three-dimensional shutter glasses, etc.

Red and blue filter glasses are relatively low in cost. However, the three-dimensional images are poor and the color is deviated. Therefore, the three-dimensional effect produced by these red and blue filter glasses is not satisfactory.

The three-dimensional effect of polarized glasses is satisfactory. Polarized glasses are largely utilized in large playgrounds. If utilized with televisions, then a polarization film needs to be coated on the screen of the television. Unfortunately, this polarization film will affect the two-dimensional images of the conventional televisions. In view of the circumstances that the occurrence of three-dimensional images is much less than two-dimensional images, it would be inappropriate to coat the television screen with a polarization film.

Regarding autostereoscopic, it does not require three-dimensional glasses and is very convenient. However, polarization films are needed to be installed on televisions and the images required filming with eight filming machines. This results in a high cost of production. Therefore, autostereoscopic is also not an ideal three-dimensional viewing system.

The advantage of three-dimensional shutter glasses is that it does not require any modifications of the television. It is sufficient so long as the frequency of the television reaches 100 Hz or 120 Hz. However, the disadvantage is that an additional shutter-glass control device for controlling the three-dimensional shutter glasses is needed to extract the vertical synchronization signal from the television. This makes installation of the three-dimensional shutter glasses difficult for a user. Furthermore, it is difficult to use it in television broadcasting because the frequency modulation unit is usually hidden inside the television and it is difficult to extract the vertical synchronization signal from the television.

There is a need to produce an improved three-dimensional viewing system that is simple, easy to use and low in cost.

The above description of the background is provided to aid in understanding the three-dimensional viewing system, but is not admitted to describe or constitute pertinent prior art to the three-dimensional viewing system disclosed in the present application, or consider any cited documents as material to the patentability of the claims of the present application.

### SUMMARY

According to one aspect, there is provided a three-dimensional viewing system including a television having an electric circuit provided therein for the generation of alternating left-eye image and right-eye image on a screen of the television, and a micro controller unit provided inside the television. The micro controller unit may be connected to the electric circuit and configured to extract a vertical synchronizing signal therefrom. The system may include an infrared transmitting unit provided at a front portion of the television. The infrared transmitting unit may be connected to the micro controller unit, and configured to receive and convert the extracted vertical synchronizing signal to an infrared signal and transmit the infrared signal towards a viewer in front of the television. An infrared receiving unit may be configured to receive the infrared signal transmitted from the infrared transmitting unit and regenerate the vertical synchronizing signal. The system includes a pair of three-dimensional shutter glasses to be worn by the viewer for holding the infrared receiving unit thereon. The pair of three-dimensional shutter glasses may have left and right liquid crystal shutter lenses connected to the infrared receiving unit and adapted to receive the regenerated vertical synchronizing signal and produce alternating transparency and opacity of the left and right liquid crystal shutter lenses. A switch unit can be provided on the pair of three-dimensional shutter glasses and connected to the left and right liquid crystal shutter lenses for independently switching the transparency and opacity thereof so that the left eye of the viewer sees the left-eye image and the right eye of the viewer sees the right-eye image thereby perceiving a three-dimensional image. The pair of three-dimensional shutter glasses may include a battery for supplying electric power to the left and right liquid crystal shutter lenses and the switch unit.

According to another aspect, there is provided a three-dimensional viewing system including an image-generating device having an electric circuit provided therein for the generation of alternating left-eye image and right-eye image on a screen of the image-generating device, and a micro controller unit provided inside the image-generating device. The micro controller unit may be connected to the electric circuit and configured to extract a vertical synchronizing signal therefrom. The system includes a pair of three-dimensional shutter glasses to be worn by a viewer. The pair of three-dimensional shutter glasses may have left and right liquid crystal shutter lenses adapted to receive the vertical synchronizing signal from the image-generating device, and produce alternating transparency and opacity of the left and right liquid crystal shutter lenses. A switch unit can be provided on the pair of three-dimensional shutter glasses and connected to the left and right liquid crystal shutter lenses for independently switching the transparency and opacity thereof so that the left eye of the viewer sees the left-eye image and the right eye of the viewer sees the right-eye image thereby perceiving a three-dimensional image.

In one embodiment, the vertical synchronizing signal can be transmitted from the image-generating device to the pair of three-dimensional shutter glasses by a wireless transmission system. The wireless transmission system may include a wireless signal transmitting unit provided at a front portion of the image-generating device, connected to the micro controller unit, and configured to receive and convert the vertical synchronizing signal to a wireless signal. A wireless signal receiving unit can be mounted on the pair of three-dimensional shutter glasses and configured to receive the wireless signal transmitted from the wireless signal transmitting unit and regenerate the vertical synchronizing signal. The wireless signal can be an infrared signal or a radio frequency signal.

In one embodiment, the vertical synchronizing signal can be transmitted from the image-generating device to the pair of three-dimensional shutter glasses through an electric wire.

According to a further aspect, there is provided a television including an electric circuit for the generation of alternating left-eye image and right-eye image on a screen of the television, and a micro controller unit provided inside the television, connected to the electric circuit and configured to extract a vertical synchronizing signal therefrom. A wireless signal transmitting unit can be provided at a front portion of the television, connected to the micro controller unit, and configured to receive and convert the extracted vertical synchronizing signal to a wireless signal and transmit the wireless signal towards a viewer in front of the television. The wireless signal can be an infrared signal or a radio frequency signal.

In one embodiment, the micro controller unit can be an additional micro controller unit connected to the electric circuit formed on an electric circuit board inside the television.

According to yet another aspect, there is provided a pair of three-dimensional shutter glasses including a wireless signal receiving unit configured to directly receive a wireless signal transmitted from a wireless signal transmitting unit on a television, and regenerate a vertical synchronizing signal from the wireless signal. The pair of three-dimensional shutter glasses includes left and right liquid crystal shutter lenses connected to the wireless signal receiving unit and adapted to receive the regenerated vertical synchronizing signal and produce alternating transparency and opacity of the left and right liquid crystal shutter lenses. The pair of three-dimensional shutter glasses may also include a switch unit connected to the left and right liquid crystal shutter lenses for independently switching the transparency and opacity thereof so that the left eye of a viewer sees the left-eye image and the right eye of the viewer sees the right-eye image thereby perceiving a three-dimensional image. The wireless signal can be an infrared signal or a radio frequency signal. The pair of three-dimensional shutter glasses may further include a battery for supplying electric power to the left and right liquid crystal shutter lenses and the switch unit.

Although the three-dimensional viewing system disclosed in the present application is shown and described with respect to certain embodiments, it is obvious that equivalents and modifications will occur to others skilled in the art upon the reading and understanding of the specification. The present application includes all such equivalents and modifications, and is limited only by the scope of the claims.

### BRIEF DESCRIPTION OF THE DRAWINGS

Specific embodiments of the three-dimensional viewing system disclosed in the present application will now be described by way of example with reference to the accompanying drawings wherein:

FIG. 1 is a block diagram showing the three-dimensional viewing system according to an embodiment of the present application.

FIG. 2 is a perspective view of a pair of three-dimensional shutter glasses of the three-dimensional viewing system according to an embodiment of the present application.

FIG. 3 is an illustrative diagram showing a viewer wearing a pair of three-dimensional shutter glasses in front of a television.

### DETAILED DESCRIPTION

Reference will now be made in detail to a preferred embodiment of the three-dimensional viewing system disclosed in the present application, examples of which are also provided in the following description. Exemplary embodiments of the three-dimensional viewing system disclosed in the present application are described in detail, although it will be apparent to those skilled in the relevant art that some features that are not particularly important to an understanding of the three-dimensional viewing system may not be shown for the sake of clarity.

Furthermore, it should be understood that the three-dimensional viewing system disclosed in the present application is not limited to the precise embodiments described below and that various changes and modifications thereof may be effected by one skilled in the art without departing from the spirit or scope of the appended claims. For example, elements and/or features of different illustrative embodiments may be combined with each other and/or substituted for each other within the scope of this disclosure and appended claims.

It should be noted that throughout the specification and claims herein, when one element is said to be “coupled” or “connected” to another, this does not necessarily mean that one element is fastened, secured, or otherwise attached to another element. Instead, the term “coupled” or “connected” means that one element is either connected directly or indirectly to another element, or is in mechanical or electrical communication with another element.

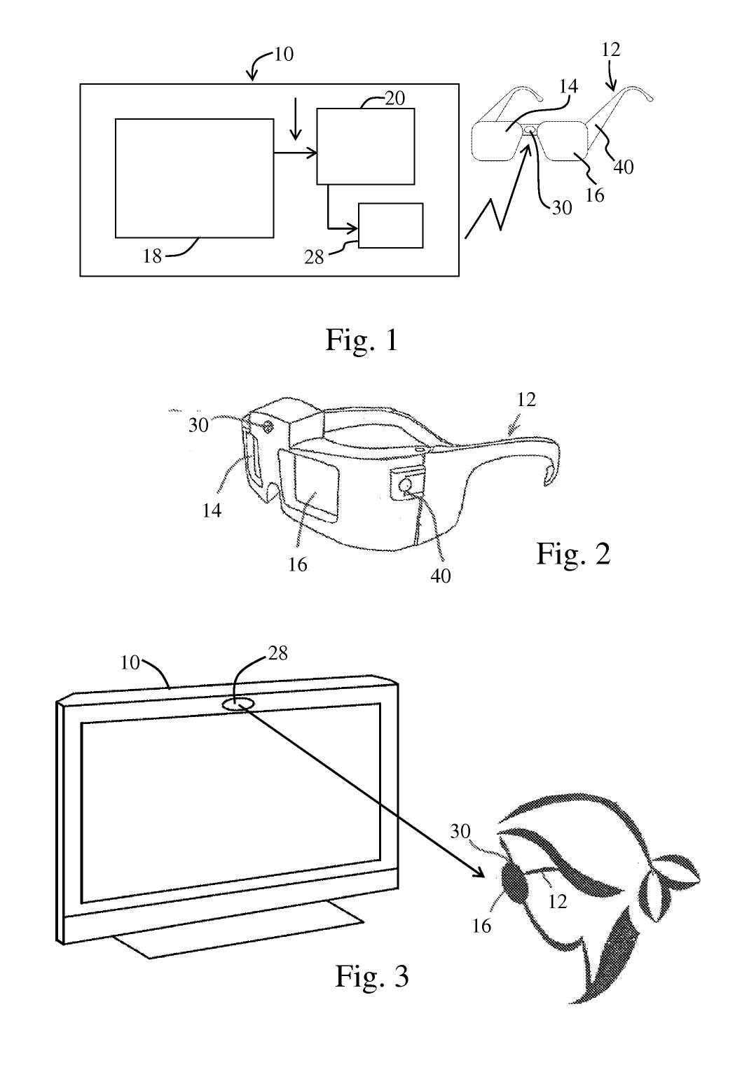

FIG. 1 is a block diagram showing the three-dimensional viewing system according to an embodiment of the present application. The three-dimensional viewing system may include an image-generating device such as a television 10 and a pair of three-dimensional shutter glasses 12 having left and right liquid crystal shutter lenses 14, 16 secured thereon.

To allow a viewer to view three-dimensional images from a flat screen of the television 10, the television 10 can be provided therein with an electric circuit board 18 with an electric circuit that can generate alternating left-eye image and right-eye image on the screen of the television 10. A viewer wearing the pair of three-dimensional shutter glasses 12 with alternating transparency/opening and opacity/closing of the left and right liquid crystal shutter lenses 14, 16 that synchronize with the alternating left-eye image and right-eye image generated on the screen of the television 10 can see the left-eye image with the left eye and the right-eye image with the right eye to perceive a three-dimensional image.

Although the television 10 has been shown as the image-generating device in the present embodiment, it is understood that the image-generating device can be any other possible devices, such as a film-projecting device or a computer, that can generate left-eye image and right-eye image on a screen for use in three-dimensional viewing.

A micro controller unit 20 can be provided inside the television 10, and configured to extract a vertical synchronizing signal from the electric circuit on the electric circuit board 18 inside the television 10. The micro controller unit 20 can be a separate, stand-alone micro controller unit connected to the electric circuit board 18, as depicted in FIG. 1. It is understood that the vertical synchronizing signal is used to control the display of the left-eye and right-eye images on the screen of the television 10. The micro controller unit 20 can be configured to separate out the vertical synchronizing signal from the electric circuit of the television 10 and use it to directly control the left and right liquid crystal shutter lenses 14, 16 of the three-dimensional shutter glasses 12.

Although it has been shown that the micro controller unit 20 is a separate micro controller unit connected to the electric circuit board 18, it is appreciated that the micro controller unit 20 may be formed on the electric circuit board 18 inside the television 10.

An infrared transmitting unit 28 may be provided at a front portion of the television 10 and may be connected to the micro controller unit 20. The infrared transmitting unit 28 may be configured to receive the vertical synchronizing signal extracted by the micro controller unit 20 from the electric circuit on the electric circuit board 18. In order to wirelessly transmit the vertical synchronizing signal to the three-dimensional shutter glasses 12, the infrared transmitting unit 28 may convert the vertical synchronizing signal to a wireless signal and then transmit the wireless signal out of the television 10 and towards a viewer in front of the television 10.

Although it has been shown and described that the vertical synchronizing signal is transmitted by an infrared signal, it is understood that the vertical synchronizing signal can also be transmitted by other suitable wireless signals such as radio frequency. Furthermore, although it has been shown and described that the vertical synchronizing signal is transmitted through a wireless transmission system, it is understood that the vertical synchronizing signal can also be transmitted through an electric wire.

An infrared receiving unit 30 may be provided on the three-dimensional shutter glasses 12. The infrared receiving unit 30 may be configured to receive the infrared signal transmitted from the infrared transmitting unit 28. The infrared receiving unit 30 may then regenerate the vertical synchronizing signal from the infrared signal.

The left and right liquid crystal shutter lenses 14, 16 of the three-dimensional shutter glasses 12 can be connected to the infrared receiving unit 30. The left and right liquid crystal shutter lenses 14, 16 may be adapted to receive the regenerated vertical synchronizing signal and produce alternating transparency/opening and opacity/closing of the left and right liquid crystal shutter lenses 14, 16.

Basically, the three-dimensional shutter glasses 12 need to know when to open and close the left and right liquid crystal shutter lenses 14, 16 and which shutter lens 14, 16 to open and close (i.e. left or right). However, the television 10 can only provide information on when to open and close the shutter lenses 14, 16 but not information on which shutter lens to open and close. In order to solve this problem, a switch unit 40 may be provided on the three-dimensional shutter glasses 12. The switch unit 40 may be connected to the left and right liquid crystal shutter lenses 14, 16 for independently switching the transparency/opening and opacity/closing of the left and right liquid crystal shutter lenses 14, 16.

When the viewer notices that the opening and closing of the left and right liquid crystal shutter lenses 14, 16 do not match the alternating left-eye and right-eye images on the screen of the television 10, the viewer can activate the switch unit 40 so that the opening and closing of the left and right liquid crystal shutter lenses 14, 16 can match with the alternating left-eye and right-eye images on the screen of the television 10 thereby perceiving a proper three-dimensional image. The three-dimensional shutter glasses 12 with the switch unit 40 may be used with televisions having different three-dimensional image standards.

It can be seen that the vertical synchronizing signal can be extracted by the micro controller unit 20 directly from the electric circuit on the electric circuit board 18 inside the television 10. The vertical synchronizing signal can then be converted to an infrared signal to directly control the three-dimensional shutter glasses 12. Therefore, a conventional separate, stand-alone 3D-shutter control device for controlling the three-dimensional shutter glasses 12 is not required in the three-dimensional viewing system of the present application. Therefore, the three-dimensional viewing system of the present application is simple in construction, easy to install and convenience to use. No additional 3D-shutter control device and no wirings are needed to be connected to the television 10 and the three-dimensional shutter glasses 12 of the present application. Since the vertical synchronizing signal for controlling the display of the left-eye image and the right-eye image on the screen of the television 10 can be readily separated out from the electric circuit in almost all televisions, it would not make the design of the television 10 of the present application more difficult. Furthermore, since a separate, stand-alone 3D-shutter control device is not required and the additional micro controller unit 20 is an inexpensive electronic component, the three-dimensional viewing system of the present application is low in cost.

The three-dimensional shutter glasses 12 of the present application can facilitate the development of three-dimensional image viewing for television broadcast, DVD, VCD, blue-ray and TV games. It can assist a television station to develop three-dimensional image broadcasting. The television station only needs to broadcast left-eye and right-eye images in 100 Hz or 120 Hz. A viewer only needs a pair of three-dimensional shutter glasses that can support the corresponding frequency. Nowadays, most of the new LCD televisions can support 100 Hz or 120 Hz. Some of the televisions can even support 200 Hz. A viewer can simply wear the three-dimensional shutter glasses 12 of the present application to view three-dimensional image broadcasting of a television station.

While the three-dimensional viewing system disclosed in the present application have been shown and described with particular references to a number of preferred embodiments thereof, it should be noted that various other changes or modifications may be made without departing from the scope of the appending claims.

What is claimed is:

1. A three-dimensional viewing system comprising:
(a) a television having an electric circuit provided therein for the generation of alternating left-eye image and right-eye image on a screen of the television;
(b) a micro controller unit provided inside the television, connected to the electric circuit and configured to extract a vertical synchronizing signal therefrom;
(c) an infrared transmitting unit provided at a front portion of the television, connected to the micro controller unit, and configured to receive and convert the extracted vertical synchronizing signal to an infrared signal and transmit the infrared signal towards a viewer in front of the television;
(d) an infrared receiving unit configured to receive the infrared signal transmitted from the infrared transmitting unit and regenerate the vertical synchronizing signal;
(e) a pair of three-dimensional shutter glasses to be worn by the viewer for holding the infrared receiving unit thereon, the pair of three-dimensional shutter glasses having left and right liquid crystal shutter lenses connected to the infrared receiving unit and adapted to receive the regenerated vertical synchronizing signal and produce alternating transparency and opacity of the left and right liquid crystal shutter lenses; and
(f) a switch unit provided on the pair of three-dimensional shutter glasses and connected to the left and right liquid crystal shutter lenses for independently switching the transparency and opacity thereof so that the left eye of the viewer sees the left-eye image and the right eye of the viewer sees the right-eye image thereby perceiving a three-dimensional image.

2. The system as claimed in claim 1, wherein the pair of three-dimensional shutter glasses comprises a battery for supplying electric power to the left and right liquid crystal shutter lenses and the switch unit.

3. A three-dimensional viewing system comprising:
(a) an image-generating device having an electric circuit provided therein for the generation of alternating left-eye image and right-eye image on a screen of the image-generating device;
(b) a micro controller unit provided inside the image-generating device, connected to the electric circuit and configured to extract a vertical synchronizing signal therefrom;
(c) a pair of three-dimensional shutter glasses to be worn by a viewer, the pair of three-dimensional shutter glasses having left and right liquid crystal shutter lenses adapted to receive the vertical synchronizing signal from the image-generating device, and produce alternating transparency and opacity of the left and right liquid crystal shutter lenses; and
(d) a switch unit provided on the pair of three-dimensional shutter glasses and connected to the left and right liquid crystal shutter lenses for independently switching the transparency and opacity thereof so that the left eye of the viewer sees the left-eye image and the right eye of the viewer sees the right-eye image thereby perceiving a three-dimensional image.

4. The system as claimed in claim 3, wherein the vertical synchronizing signal is transmitted from the image-generating device to the pair of three-dimensional shutter glasses by a wireless transmission system, the wireless transmission system comprises:
(a) a wireless signal transmitting unit provided at a front portion of the image-generating device, connected to the micro controller unit, and configured to receive and convert the vertical synchronizing signal to a wireless signal; and
(b) a wireless signal receiving unit mounted on the pair of three-dimensional shutter glasses and configured to receive the wireless signal transmitted from the wireless signal transmitting unit and regenerate the vertical synchronizing signal.

5. The system as claimed in claim 4, wherein the wireless signal is an infrared signal.

6. The system as claimed in claim 4, wherein the wireless signal is a radio frequency signal.

7. The system as claimed in claim 3, wherein the vertical synchronizing signal is transmitted from the image-generating device to the pair of three-dimensional shutter glasses through an electric wire.

8. The system as claimed in claim 3, wherein the pair of three-dimensional shutter glasses comprises a battery for supplying electric power to the left and right liquid crystal shutter lenses and the switch unit.

9. The system as claimed in claim 3, wherein the image-generating device is a television.

10. A television comprising:
(a) an electric circuit for the generation of alternating left-eye image and right-eye image on a screen of the television;
(b) a micro controller unit provided inside the television, connected to the electric circuit and configured to extract a vertical synchronizing signal therefrom; and
(c) a wireless signal transmitting unit provided at a front portion of the television, connected to the micro controller unit, and configured to receive and convert the extracted vertical synchronizing signal to a wireless signal and transmit the wireless signal towards a viewer in front of the television.

11. The television as claimed in claim 10, wherein the wireless signal is an infrared signal.

12. The television as claimed in claim 10, wherein the wireless signal is a radio frequency signal.

13. The television as claimed in claim 10, wherein the micro controller unit is an additional micro controller unit connected to the electric circuit formed on an electric circuit board inside the television.

14. A pair of three-dimensional shutter glasses comprising:
(a) a wireless signal receiving unit configured to directly receive a wireless signal transmitted from a wireless signal transmitting unit on a television, and regenerate a vertical synchronizing signal from the wireless signal;
(b) left and right liquid crystal shutter lenses connected to the wireless signal receiving unit and adapted to receive the regenerated vertical synchronizing signal and produce alternating transparency and opacity of the left and right liquid crystal shutter lenses; and
(c) a switch unit connected to the left and right liquid crystal shutter lenses for independently switching the transparency and opacity thereof so that the left eye of a viewer sees the left-eye image and the right eye of the viewer sees the right-eye image thereby perceiving a three-dimensional image.

15. The pair of three-dimensional shutter glasses as claimed in claim 14, wherein the wireless signal is an infrared signal.

16. The pair of three-dimensional shutter glasses as claimed in claim 14, wherein the wireless signal is a radio frequency signal.

17. The pair of three-dimensional shutter glasses as claimed in claim 14, further comprising a battery for supplying electric power to the left and right liquid crystal shutter lenses and the switch unit.
